(19) United States
(12) Patent Application Publication
(10) Pub. No.: US 2024/0354406 A1
(43) Pub. Date: Oct. 24, 2024

(54) MALICIOUS PATTERN MATCHING USING GRAPH NEURAL NETWORKS

(71) Applicant: Avast Software s.r.o., Prague 4 (CZ)

(72) Inventors: Václav Belák, Havlíckova Borová (CZ); Martin Bálek, Teplice (CZ); Tomáš Strenácik, Banska Bystrica (SK); Bretislav Šopík, Zdar nad Sazavou (CZ)

(73) Assignee: Avast Software s.r.o., Prague 4 (CZ)

(21) Appl. No.: 18/305,940

(22) Filed: Apr. 24, 2023

(51) Int. Cl. G06F 21/55; G06N 3/08

(52) U.S. Cl. CPC G06F 21/554; G06N 3/08; G06F 2221/034

(57) ABSTRACT

A method of detecting likely malicious activity in a sequence of computer instructions includes identifying a set of behaviors of the computer instructions and representing the identified behaviors as a graph. The graph is provided to a graph neural network that is trained to generate a geometric representation of the sequence of computer instructions, and a degree of relatedness between the geometric representation of the computer instructions and a set of base graphs including base graphs known to be malicious is determined. The sequence of computer instructions is determined to likely be malicious or clean based on a degree of relatedness between the geometric representation of the computer instructions and one or more base graphs known to be malicious.

### FIELD

The invention relates generally to detection of malicious activity in computer systems, and more specifically to matching malicious patterns using graph neural networks (GNN).

### BACKGROUND

Computers are valuable tools in large part for their ability to communicate with other computer systems and retrieve information over computer networks. Networks typically comprise an interconnected group of computers, linked by wire, fiber optic, radio, or other data transmission means, to provide the computers with the ability to transfer information from computer to computer. The Internet is perhaps the best-known computer network, and enables millions of people to access millions of other computers such as by viewing web pages, sending e-mail, or by performing other computer-to-computer communication.

However, as the size of the Internet is so large and Internet users are so diverse in their interests, it is not uncommon for malicious users or pranksters to attempt to communicate with other users' computers in a manner that poses a danger to the other users. For example, a hacker may attempt to log in to a corporate computer to steal, delete, or change information. Computer viruses or Trojan horse programs may be distributed to other computers or unknowingly downloaded such as through email, download links, or smartphone apps. Further, computer users within an organization such as a corporation may on occasion attempt to perform unauthorized network communications, for example, running file sharing programs or transmitting corporate secrets from within the corporation's network to the Internet.

For these and other reasons, many computer systems employ a variety of safeguards designed to protect computer systems against certain threats. Firewalls restrict the types of communication that can occur over a network, antivirus programs are designed to prevent malicious code from being loaded or executed on a computer system, and malware detection programs are designed to detect remailers, keystroke loggers, and other software that is designed to perform undesired operations such as stealing information from a computer or using the computer for unintended purposes. Similarly, web site scanning tools are used to verify the security and integrity of a website, and to identify and fix potential vulnerabilities.

For example, antivirus or antimalware software compares a data set of known malicious executable code to executable code installed on a computer or loaded into the computer's memory, and blocks execution of code determined likely to be malicious. But, identifying a match between known malicious code and code on an end user's computer can be challenging, especially as malware developers seek to hide or change the way malware is encoded to avoid detection. Matching behavior of code can solve some of these problems, however it is a much more difficult process than matching the code itself because of the computational difficulty of characterizing and matching behavior given the fact that typically only a small portion of code (or functional behavior) in an executable is typically malicious.

It is therefore desirable to manage the analysis of code execution on a computerized system to provide more effective and efficient detection of vulnerabilities.

### SUMMARY

In one example, detecting likely malicious activity in computer instructions of an application (or “app”) includes identifying a set of behaviors of the computer instructions, and representing the identified behaviors as a graph. The graph is provided to a graph neural network that is trained to generate a geometric representation of the sequence of computer instructions, and a degree of relatedness between the geometric representation of the computer instructions and a set of base graphs including base graphs known to be malicious is determined. The sequence of computer instructions is determined to be likely malicious or clean based on a degree of relatedness between the geometric representation of the computer instructions and one or more base graphs known to be malicious.

In another example, a graph neural network is trained to identify malicious behavior in sequences of computer instructions. A set of behaviors of a sequence of computer instructions is identified in a training sample known to be either malicious or clean. Each of the plurality of identified behaviors are represented as a full graph identified as either malicious or clean based on the known behavior of the sequence of computer instructions. Each of a subset of behaviors of the full graph are represented as a subgraph comprising a set of the most relevant elements of the full graph, the subgraph is also identified as malicious or clean based on the known behavior of the sequence of computer instructions.

An opposite set of behaviors is represented as an opposite graph identified as malicious if the full graph and subgraph are identified as clean, and identified as clean if the full graph and subgraph are identified as malicious, where the opposite graph selected from a training set of graphs is similar in behavior to full graph and first subgraph. The graph neural network is then trained with the full graph, the first subgraph, and the opposite graph to distinguish between graphs having malicious and clean behavior.

In a further example, a triplet loss function is used with the full graph, the first subgraph, and the opposite graph to train the graph neural network.

The details of one or more examples of the invention are set forth in the accompanying drawings and the description below. Other features and advantages will be apparent from the description and drawings, and from the claims.

### BRIEF DESCRIPTION OF THE FIGURES

FIG. 1 shows a graph neural network antimalware development system in a networked environment, consistent with an example embodiment.

FIG. 2 is a block diagram showing use of a full graph, a subgraph, and an opposite graph to train a graph neural network, consistent with an example embodiment.

FIG. 3 is a flowchart of a method of using a graph neural network to detect malware, consistent with an example embodiment.

FIG. 4 shows an example method of training a graph neural network to recognize malicious computer instruction sequences, consistent with an example embodiment.

FIG. 5 is a computerized malware detection training system, consistent with an example embodiment.

### DETAILED DESCRIPTION

In the following detailed description of example embodiments, reference is made to specific example embodiments by way of drawings and illustrations. These examples are described in sufficient detail to enable those skilled in the art to practice what is described, and serve to illustrate how elements of these examples may be applied to various purposes or embodiments. Other embodiments exist, and logical, mechanical, electrical, and other changes may be made.

Features or limitations of various embodiments described herein, however important to the example embodiments in which they are incorporated, do not limit other embodiments, and any reference to the elements, operation, and application of the examples serve only to define these example embodiments. Features or elements shown in various examples described herein can be combined in ways other than shown in the examples, and any such combinations is explicitly contemplated to be within the scope of the examples presented here. The following detailed description does not, therefore, limit the scope of what is claimed.

As networked computers and computerized devices such as smart phones become more ingrained into our daily lives, the value of the information they store, the data such as passwords and financial accounts they capture, and even their computing power becomes a tempting target for criminals. Hackers regularly attempt to log in to a corporate computer to steal, delete, or change information, or to encrypt the information and hold it for ransom via “ransomware.” Computer applications, smartphone apps, and even documents such as Microsoft Word documents containing macros are all frequently infected with malware of various types, and users rely on tools such as antivirus software or other malware protection tools to protect their computerized devices from harm.

In a typical home computer or corporate computing environment, firewalls inspect and restrict the types of communication that can occur over a network, antivirus programs prevent known malicious code from being loaded or executed on a computer system, and malware detection programs detect known malicious code such as remailers, keystroke loggers, and other software that is designed to perform undesired operations such as stealing information from a computer or using the computer for unintended purposes.

Detection of malicious code was first done by comparing known malicious code to code that is installed or executed on a computer system, such as where a segment of malicious code that infects an executable file could be identified and execution of the executable could be stopped. But, malware developers frequently change the way the code itself is expressed, using obfuscation techniques to hide malicious code from antimalware (and antivirus) software. Some sophisticated antimalware software tries to block malicious code by observing the behavior of code installed or executing on a computer, and comparing it to behavior of code known to be malicious.

Identifying behavioral patterns of code known to be malicious and comparing these behavioral patterns to code on the user's computer is a complex task, and is both very computationally expensive and relies on differentiation between malicious and benign behavior in both the known malware and user's computer. For example, collecting snapshots of behavior observed on millions of computers each day and finding patterns of malicious behavior in the code requires significant computational resources and efficient characterization of the behavioral data. Also, much of the behavior of a typical application is benign, and determining which behaviors are malicious in a typical application or set of code can be difficult.

Some examples described herein therefore seek to improve the performance of antimalware and other such software by incorporating a graph neural network trained to identify patterns of behaviors that are likely malicious. In one example, malicious activity encoded in computer instructions of an app includes identifying a set of behaviors of the computer instructions, and representing the identified behaviors as a graph. The graph is provided to a graph neural network that is trained to generate a geometric representation of the sequence of computer instructions, and a degree of relatedness between the geometric representation of the computer instructions and a set of base graphs including base graphs known to be malicious is determined. The sequence of computer instructions is determined to likely be malicious or clean based on a degree of relatedness between the geometric representation of the computer instructions and one or more base graphs known to be malicious.

In another example, a graph neural network is trained to identify malicious behavior in computer instruction sequences. A set of behaviors of a sequence of computer instructions is identified in a training sample known to be either malicious or clean. The plurality of identified behaviors is represented as a full graph identified as either malicious or clean based on the known behavior of the sequence of computer instructions. A subset of behaviors of the full graph is represented as a subgraph comprising a set of the most relevant elements of the full graph, the subgraph is also identified as malicious or clean based on the known behavior of the sequence of computer instructions. An opposite set of behaviors is represented as an opposite graph identified as malicious if the full graph and subgraph are identified as clean, and identified as clean if the full graph and subgraph are identified as malicious, where the opposite graph selected from a training set of graphs is similar in behavior to full graph and first subgraph. The graph neural network is then trained with the full graph, the first subgraph, and the opposite graph to distinguish between graphs having malicious and clean behavior.

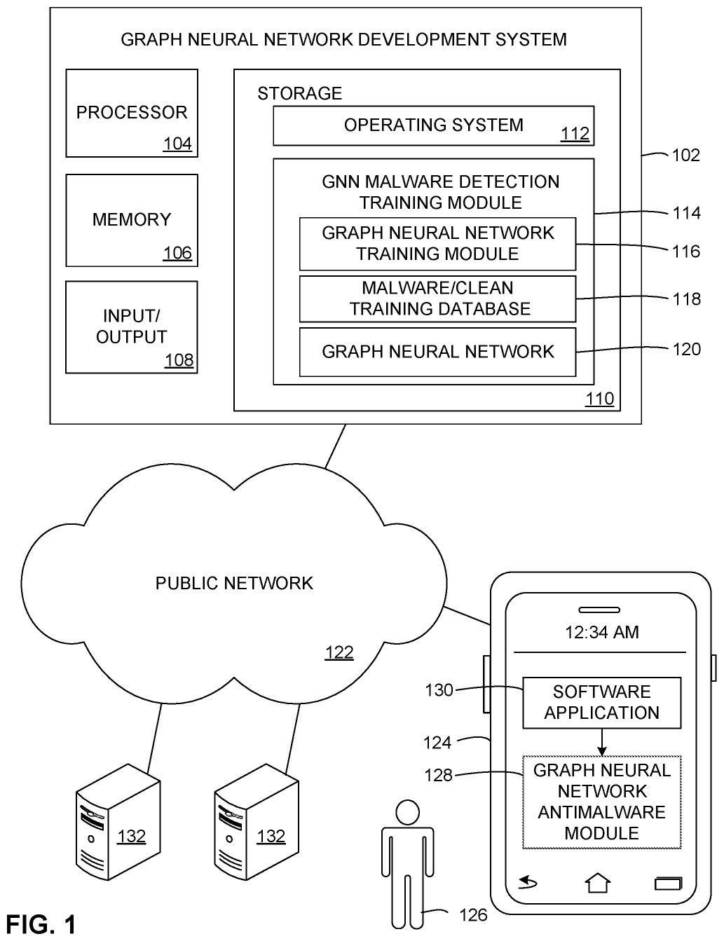

FIG. 1 shows a graph neural network antimalware development system in a networked environment, consistent with an example embodiment. Here, a graph neural network development system 102 comprises a processor 104, memory 106, input/output elements 108, and storage 110. Storage 110 includes an operating system 112, and a graph neural network training module 114 that is operable to train a graph neural network to detect malicious program instructions, such as when installed in a user device such as smart phone 124 or provided as a cloud service via a computer such as a remote server 132. The graph neural network training module 114 further comprises graph neural network training module 116 operable to train the graph neural network such as by providing an expected output for a given sequence of input and backpropagating the difference between the actual output and the expected output. The graph neural network trains by altering its configuration, such as multiplication coefficients used to produce an output from a given input to reduce or minimize the observed difference between the expected output and observed output. A malware/clean training database 118 includes a variety of malicious software instructions sequences or code that can be used to train the graph neural network, and in a further example includes a variety of non-malicious or clean code that can be used to help train the neural network to avoid false positives. The graph neural network being trained is shown at 120, and upon completion of initial training or completion of a training update is distributed such as via a public network 122 (such as the Internet, or a cellular network) to end user devices such as smart phone 124.

In operation, a user 126 installs the graph neural network onto a computerized device such as smart phone 124, such as by downloading and installing it as an application or selecting to run it as a service as part of the smart phone's preconfigured software. Once installed and active, the graph neural network antimalware module 128 on smartphone 124 in this example is operable to scan software applications 130, such as those downloaded from an app store or a remote server 132, and to scan other content such as Java applets that the user 126 may download such as from a web server 132.

In a more detailed example, the graph neural network antimalware module installed on smart phone 124 is operable to scan a newly-downloaded software application 130 before installation, immediately after installation, or as the newly-installed application is executed for the first time. If the graph neural network module determines that the application is likely malicious, it notifies the user, stops execution of the application, uninstalls the application, or performs other such functions to restrict execution of the malicious instructions and/or notify the user in various examples, thereby protecting the user 126's smart phone 124 from malware.

The graph neural network in this example evaluates computer instructions in a software application 130 by identifying a set of behaviors of the application's computer instructions, and representing the identified behaviors as a graph. The graph is provided to a graph neural network antimalware module 128 that has a graph neural network 120 that is trained to generate a geometric representation of the sequence of computer instructions, and a degree of relatedness between the geometric representation of the computer instructions and a set of base graphs including base graphs known to be malicious is determined. The application 130's sequence of computer instructions is determined to likely be malicious or clean based on a degree of relatedness between the geometric representation of the computer instructions and one or more base graphs known to be malicious.

The graph neural network 120 in this example is trained to identify malicious behavior in computer instruction sequences via graph neural network training module 116, which uses malware/clean training database 118 to train the graph neural network. A set of behaviors of a sequence of computer instructions from a training sample from malware/clean training database 118 is known to be either malicious or clean. The set of behaviors are represented as a full graph identified as either malicious or clean based on the known behavior of the training sample's computer instructions. A subset of behaviors of the full graph are represented as a subgraph comprising a set of the most relevant elements of the full graph, and the subgraph is also identified as malicious or clean based on the known behavior of the training sample's computer instructions. An opposite set of behaviors are represented as an opposite graph identified as malicious if the full graph and subgraph are identified as clean, and identified as clean if the full graph and subgraph are identified as malicious, where the opposite graph selected from the training samples in malware/clean training database to be similar in behavior to full graph and first subgraph.

The graph neural network is then trained with the full graph, the first subgraph, and the opposite graph to distinguish between graphs having malicious and clean behavior, such as using a triplet loss function which optimizes the neural network's ability to place at a close distance any two graphs that are subisomorphic and to place far apart any two graphs that are not subisomorphic. The network is thus optimized to recognize the structural similarity or dissimilarity of graphs and features of the graphs, such as nodes and edges, such that the degree of relatedness between any two graphs may be determined by measuring their distance using known measurement functions such as a cosine metric. Thus, otherwise related graphs with non-relevant slight differences between themselves will have a distance near zero.

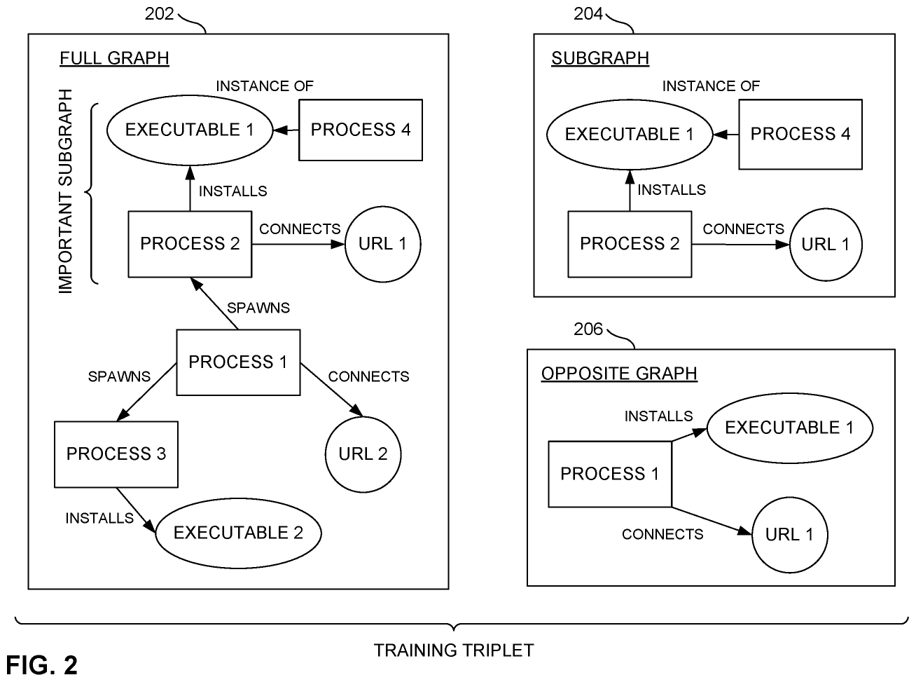

FIG. 2 is a block diagram showing use of a full graph, a subgraph, and an opposite graph to train a graph neural network, consistent with an example embodiment. FIG. 2 shows a full graph representing a simplified set of behaviors of a sequence of computer instructions represented in graph form at 202, as well as a subgraph of the full graph at 204 and an opposite graph at 206. The graphs in this example include multiple executables and processes as well as functions such as network activity and URLs (Uniform Resource Locator strings) visited, but in other examples include functions or behaviors other than those shown here.

The full graph shown at 202 includes multiple processes that spawn other processes, install executables, and connect to URLs. The graph shows both the elements, including processes, executables, and graphs, as well as the relationship between elements in the graph. More specifically, the full graph shown at 202 includes a process 1 that spawns process 2 and process 3, and connects to URL 2 via a network connection. Process 3 installs executable 2. In the section labeled “important subgraph,” process 2 connects to URL1 and installs executable 1. Executable 1 executes or runs, and process 4 is an executing instance of executable 1.

The four elements in the section labeled “important subgraph” have in this simplified example been determined to be the relevant or important parts of the graph in determining that the graph represents a sequence of instructions having malicious behavior. In some examples, this is determined by a separate machine learning system such as another neural network, and in other examples is determined by subject matter experts or by other means.

The “important subgraph” elements and their relationships are shown in the subgraph 204, which has the same malicious or clean designation as the full graph 202. The subgraph 204 includes the most important elements in determining whether the full graph 202 is malicious or clean, such as the nodes, edges, and relationships between nodes that contribute to the determination of whether the full graph is malicious or clean.

Opposite graph 206 has the opposite malicious or clean designation as the full graph 202 and the subgraph 204, and is selected from a training set of graphs that have the desired malicious or clean designation such that the opposite graph closely resembles the full graph 202. In an alternate example, the opposite graph is selected to closely resemble the full graph 202 and the subgraph 204. Because the opposite graph has the opposite malicious or clean label as the full graph 202 and the subgraph 204, the graph neural network trained on the three graphs as a training triplet is forced to improve its discrimination between the opposite graph 206 and other two graphs in the training triplet having opposite malicious or clean designations.

Matching a sequence of computer instructions in one example comprises finding the shortest distance between graphs in the geometric space. When evaluating a sequence of computer instructions using a trained graph neural network, the graph representing the sequence of computer instructions is compared to known graphs representing known malicious and clean instructions, and the known graph with the shortest distance to the graph representing the sequence of computer instructions being tested is determined. The malicious or clean designation of the known graph having the shortest distance to the graph being tested is then output as the likely malicious or clean behavior of the graph being tested.

The example approach described here enables the graph neural network to generalize beyond strict matches, such that differences that are minor or insignificant to a graph's behavior can be overlooked in determining whether a graph representation of a sequence of computer instructions has malicious or clean behavior. Recognition of graphs with differences that are small or insignificant can be further enhanced by using a nonlinear function such as the cosine function to determine the degree of relatedness from the geometric distance. Because the graph neural network is trained on full graphs, subgraphs that are a subset or sub-isomorphic of the full graph, and opposite graphs, relationships between graphs that come from different contexts can be recognized and learned to a greater degree than with many other approaches.

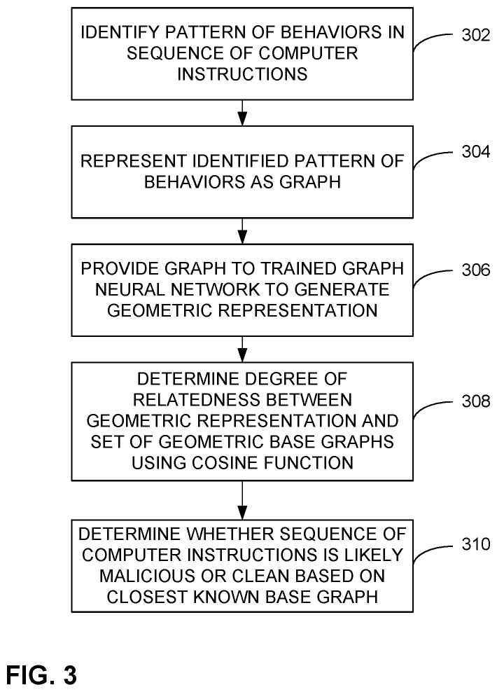

FIG. 3 is a flowchart of a method of using a graph neural network to detect malware, consistent with an example embodiment. At 302, a sequence of computer instructions is broken up into or represented as a pattern of behaviors, such as launching a process, spawning a process, communicating with a remote Internet address, or the like. This pattern of behaviors of the sequence of computer instructions is represented as a graph at 304, and the graph is provided to a trained graph neural network for processing at 306. The graph neural network outputs a geometric representation of the graph, and at 308 the degree of relatedness between the geometric representation of the sequence of computer instructions and various other geometric representations in a set of base graphs is determined. The set of base graphs desirably contains geometric representations of both clean computer instruction sequences and malicious computer instruction sequences, such that the distance between the geometric representation of the sequence of computer instructions in 302 and various clean and malicious sequences coded in the set of geometric base graphs can be calculated.

When the closest graph from the set of geometric base graphs is found, the sequence of computer instructions is determined likely clean or likely malicious based on the clean or malicious nature of the closest base graph at 310. In a further example, minor differences between graphs are given less weight, such as by using a cosine function or other suitable function to calculate the distance between graphs embedded in the abstract geometric space. In another example, threshold distances are set for reaching various conclusions, such as the closest clean graph being at least a threshold distance or percentage distance farther away in geometric distance from the sample under test than the closest malware graph for a graph to be determined likely malware. This margin can be adjusted to balance the chance of potential missed malicious program instructions against the potential of false identification of an instruction sequence as malware, as users desire protection from malware but are often very sensitive to false malware identification.

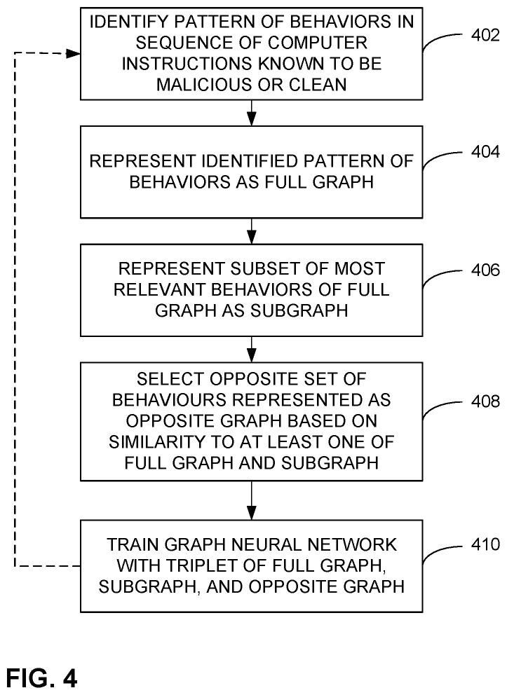

FIG. 4 shows an example method of training a graph neural network to recognize malicious computer instruction sequences, consistent with an example embodiment. At 402, a pattern of behaviors in a training sample of computer instructions known to be malicious or clean is identified. The pattern of behaviors is represented as a full graph at 402, and the most relevant parts of the subgraph for determination of the full graph as clean or malicious are identified. Identifying the most relevant parts in various examples is performed by another trained neural network, by a human, or by other suitable means. The subset of most relevant behaviors of the full graph are represented at 406 as a subgraph having the same known malicious or clean identification as the full graph.

At 408, a set of graphs having known malicious or benign behavior is searched for an opposite graph most resembling the full graph, the subgraph, or both the full graph and the subgraph, but that has the opposite malicious or benign identification as the full graph and the subgraph. This opposite graph is therefore opposite in malicious or clean behavior, but close to the full graph and/or the subgraph and a good candidate for training a graph neural network to distinguish between similar malicious and clean graphs and computer instruction sequences.

The graph neural network is therefore trained with the triplet of graphs of the full graph, the subgraph, and the opposite graph, such as by using a triplet loss function with each of the three graphs in the triplet of training graphs provided as inputs. This process repeats at 402 for a number of additional training computer instruction sequences so that the graph neural network can accurately detect a wide variety of types of malicious computer code.

In other embodiments, training may be achieved with a triplet of a full graph, a subgraph, and an opposite graph, where the full graph is a full graph representing a real or observed behavioral snapshot; the subgraph is a subgraph induced from the full graph by randomly pruning its nodes with a probability of pₙ, and the opposite graph is generated from the subgraph by randomly replacing its edges with a probability of pₑ from the complement graph, and by randomly permuting the nodes' features with probability p_{f}. Training in this matter ensures that the subgraph is subisomorphic to the full graph while the opposite graph is not (since both its structure and nodes' features have been permuted). The probability parameters pₑ, and p_{f} control the extent to which the GNN model will focus on either the structure (pₑ) or the nodes features (p_{f}), while the pₙ parameter determines generally the difference in sizes of the full graphs and the subgraphs and can be tuned along with other hyperparameters of the model.

The examples described herein show how use of a graph neural network can help identify malicious computer code based on behavior of the code better than many prior approaches. By embedding the graphs within a geometric space, pattern matching can be approached by finding the geometric distance between a computer instruction sequence being evaluated and a reference set of geometric space representations of other graphs known to be malicious or clean. If a geometric space of low rank is chosen, such as 32 dimensions, even information-rich and structurally large graphs having thousands of nodes and edges can be efficiently represented and compared.

The distance calculation further enables malware researchers to identify other graphs and associated computer instruction sequences that are most similar to a new graph or instruction sequence, enabling the researcher to better focus on likely new malware and understand its possible source and relation to other known malware. Researchers can therefore focus first on the closest matches, which can significantly reduce the cognitive burden in the context of millions of new graphs collected every day in a typical antimalware product environment.

In alternate applications, the graph neural network methods described herein can be applied to other pattern recognition examples, such as examining financial transactions to identify money laundering and identifying malicious websites by a graph of their linkage, content, geographic location, and the like.

The computerized systems such as the graph neural network development system 102 of FIG. 1 used to train the graph neural network and the smart phone 124 that executes the graph neural network to protect against malicious programs or applications can take many forms, and are configured in various embodiments to perform the various functions described herein.

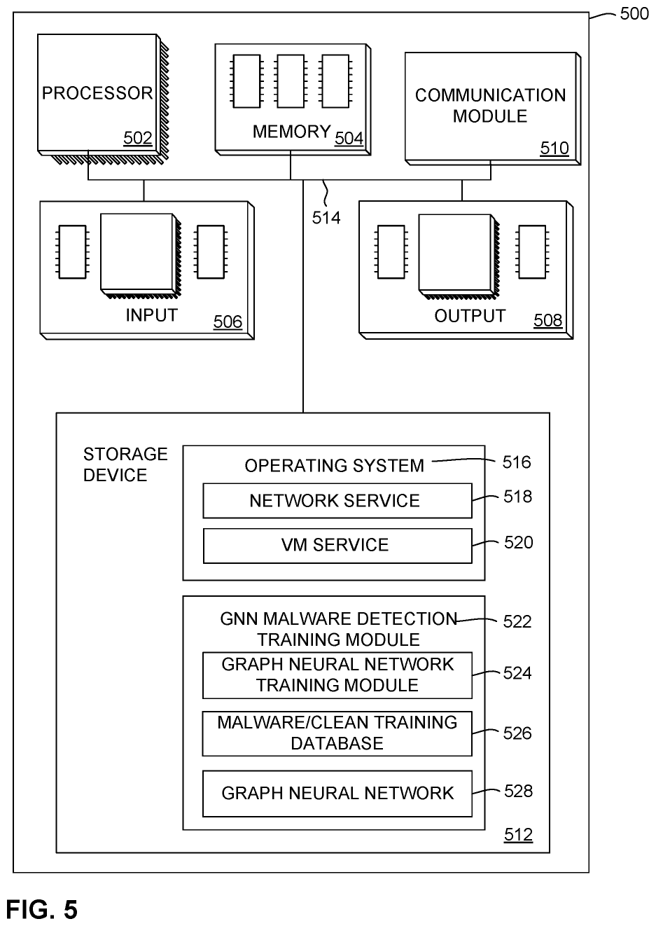

FIG. 5 is a computerized malware detection training system, consistent with an example embodiment. FIG. 5 illustrates only one particular example of computing device 500, and other computing devices 500 may be used in other embodiments. Although computing device 500 is shown as a standalone computing device, computing device 500 may be any component or system that includes one or more processors or another suitable computing environment for executing software instructions in other examples, and need not include all of the elements shown here.

As shown in the specific example of FIG. 5, computing device 500 includes one or more processors 502, memory 504, one or more input devices 506, one or more output devices 508, one or more communication modules 510, and one or more storage devices 512. Computing device 500, in one example, further includes an operating system 516 executable by computing device 500. The operating system includes in various examples services such as a network service 518 and a virtual machine service 520 such as a virtual server. One or more applications, such as GNN malware detection training module 522 are also stored on storage device 512, and are executable by computing device 500.

Each of components 502, 504, 506, 508, 510, and 512 may be interconnected (physically, communicatively, and/or operatively) for inter-component communications, such as via one or more communications channels 514. In some examples, communication channels 514 include a system bus, network connection, inter-processor communication network, or any other channel for communicating data. Applications such as malware evaluation module 522 and operating system 516 may also communicate information with one another as well as with other components in computing device 500.

Processors 502, in one example, are configured to implement functionality and/or process instructions for execution within computing device 500. For example, processors 502 may be capable of processing instructions stored in storage device 512 or memory 504. Examples of processors 502 include any one or more of a microprocessor, a controller, a digital signal processor (DSP), an application specific integrated circuit (ASIC), a field-programmable gate array (FPGA), or similar discrete or integrated logic circuitry.

One or more storage devices 512 may be configured to store information within computing device 500 during operation. Storage device 512, in some examples, is known as a computer-readable storage medium. In some examples, storage device 512 comprises temporary memory, meaning that a primary purpose of storage device 512 is not long-term storage. Storage device 512 in some examples is a volatile memory, meaning that storage device 512 does not maintain stored contents when computing device 500 is turned off. In other examples, data is loaded from storage device 512 into memory 504 during operation. Examples of volatile memories include random access memories (RAM), dynamic random access memories (DRAM), static random access memories (SRAM), and other forms of volatile memories known in the art. In some examples, storage device 512 is used to store program instructions for execution by processors 502. Storage device 512 and memory 504, in various examples, are used by software or applications running on computing device 500 such as GNN malware detection training module 522 to temporarily store information during program execution.

Storage device 512, in some examples, includes one or more computer-readable storage media that may be configured to store larger amounts of information than volatile memory. Storage device 512 may further be configured for long-term storage of information. In some examples, storage devices 512 include non-volatile storage elements. Examples of such non-volatile storage elements include magnetic hard discs, optical discs, floppy discs, flash memories, or forms of electrically programmable memories (EPROM) or electrically erasable and programmable (EEPROM) memories.

Computing device 500, in some examples, also includes one or more communication modules 510. Computing device 500 in one example uses communication module 510 to communicate with external devices via one or more networks, such as one or more wireless networks. Communication module 510 may be a network interface card, such as an Ethernet card, an optical transceiver, a radio frequency transceiver, or any other type of device that can send and/or receive information. Other examples of such network interfaces include Bluetooth, 4G, LTE, or 5G, WiFi radios, and Near-Field Communications (NFC), and Universal Serial Bus (USB). In some examples, computing device 500 uses communication module 510 to wirelessly communicate with an external device such as via public network 122 of FIG. 1.

Computing device 500 also includes in one example one or more input devices 506. Input device 506, in some examples, is configured to receive input from a user through tactile, audio, or video input. Examples of input device 506 include a touchscreen display, a mouse, a keyboard, a voice responsive system, video camera, microphone or any other type of device for detecting input from a user.

One or more output devices 508 may also be included in computing device 500. Output device 508, in some examples, is configured to provide output to a user using tactile, audio, or video stimuli. Output device 508, in one example, includes a display, a sound card, a video graphics adapter card, or any other type of device for converting a signal into an appropriate form understandable to humans or machines. Additional examples of output device 508 include a speaker, a light-emitting diode (LED) display, a liquid crystal display (LCD), or any other type of device that can generate output to a user.

Computing device 500 may include operating system 516. Operating system 516, in some examples, controls the operation of components of computing device 500, and provides an interface from various applications such as GNN malware detection training module 522 to components of computing device 500. For example, operating system 516, in one example, facilitates the communication of various applications such as GNN malware detection training module 522 with processors 502, communication unit 510, storage device 512, input device 506, and output device 508. Applications such as GNN malware detection training module 522 may include program instructions and/or data that are executable by computing device 500. As one example, GNN malware detection training module 522 executes graph neural network training module 524 using malware/clean training database 526 to train graph neural network 528 to identify malicious sequences of program instructions. These and other program instructions or modules may include instructions that cause computing device 500 to perform one or more of the other operations and actions described in the examples presented herein.

Although specific embodiments have been illustrated and described herein, any arrangement that achieve the same purpose, structure, or function may be substituted for the specific embodiments shown. This application is intended to cover any adaptations or variations of the example embodiments of the invention described herein. These and other embodiments are within the scope of the following claims and their equivalents.

1. A method of identifying malicious activity in a sequence of computer instructions, comprising:
identifying a plurality of behaviors of the sequence of computer instructions;
representing the plurality of identified behaviors as a graph;
providing the graph to a graph neural network that is trained to generate a geometric representation of the sequence of computer instructions;
determining a degree of relatedness between the geometric representation of the computer instructions and a plurality of base graphs including base graphs known to be malicious, and;
determining whether the sequence of computer instructions is likely malicious based on a degree of relatedness between the geometric representation of the computer instructions and one or more base graphs known to be malicious.

2. The method of identifying malicious activity in a sequence of computer instructions of claim 1, wherein:
determining a degree of relatedness between the geometric representation of the computer instructions and a plurality of base graphs further includes one or more base graphs known to be clean; and
determining whether the sequence of computer instructions is likely malicious further comprises determining a degree of relatedness between the geometric representation of the computer instructions and one or more base graphs known to be clean.

3. The method of identifying malicious activity in a sequence of computer instructions of claim 1, wherein determining a degree of relatedness further comprises determining a distance between the geometric representation of the computer instructions and one or more base graphs.

4. The method of identifying malicious activity in a sequence of computer instructions of claim 3, wherein determining a distance comprises using a cosine metric of the distance between the geometric representation of the computer instructions and one or more base graphs.

5. The method of identifying malicious activity in a sequence of computer instructions of claim 4, wherein the geometric representation is configured to allow for non-relevant slight differences between otherwise related graphs.

6. The method of identifying malicious activity in a sequence of computer instructions of claim 1, wherein the graph neural network is trained with a triplet loss function.

7. The method of identifying malicious activity in a sequence of computer instructions of claim 1, wherein the graph neural network is implemented in a computerized system.

8. A computerized system operable to identify malicious activity in a target sequence of computer instructions, comprising:
a processor operable to execute computer instructions;
a stored sequence of computer instructions operable when executed on the processor to:
identify a plurality of behaviors of the target sequence of computer instructions;
represent the plurality of identified behaviors as a graph;
provide the graph to a graph neural network that is trained to generate a geometric representation of the target sequence of computer instructions;
determine a degree of relatedness between the geometric representation of the target computer instructions and a plurality of base graphs including base graphs known to be malicious, and;
determine whether the target sequence of computer instructions is likely malicious based on a degree of relatedness between the geometric representation of the target computer instructions and one or more base graphs known to be malicious.

9. The computerized system operable to identify malicious activity in a target sequence of computer instructions of claim 8, wherein:
determining a degree of relatedness between the geometric representation of the target computer instructions and a plurality of base graphs further includes one or more base graphs known to be clean; and
determining whether the target sequence of computer instructions is likely malicious further comprises determining a degree of relatedness between the geometric representation of the target computer instructions and one or more base graphs known to be clean.

10. The computerized system operable to identify malicious activity in a target sequence of computer instructions of claim 8, wherein determining a degree of relatedness further comprises determining a distance between the geometric representation of the target computer instructions and one or more base graphs.

11. The computerized system operable to identify malicious activity in a target sequence of computer instructions of claim 10, wherein determining a distance comprises using a cosine metric of the distance between the geometric representation of the target computer instructions and one or more base graphs.

12. The computerized system operable to identify malicious activity in a sequence of computer instructions of claim 11, wherein the cosine metric is configured to allow for non-relevant slight differences between otherwise related graphs.

13. The method of identifying malicious activity in a sequence of computer instructions of claim 8, wherein the graph neural network is trained with a triplet loss function.

14. The method of identifying malicious activity in a sequence of computer instructions of claim 8, wherein the stored sequence of computer instructions is executed on an end user computerized device.

15. The method of identifying malicious activity in a sequence of computer instructions of claim 8, wherein the stored sequence of computer instructions is executed on a remote server.

16. A method of training a graph neural network to identify malicious activity in a sequence of computer instructions, comprising:
identifying a plurality of behaviors of the sequence of computer instructions, the sequence of computer instructions known to be either malicious or clean;
representing the plurality of identified behaviors as a full graph identified as either malicious or clean based on the known behavior of the sequence of computer instructions;
representing a subset of behaviors of the full graph as a subgraph comprising a set of most relevant elements of the full graph, the subgraph identified as malicious or clean based on the known behavior of the sequence of computer instructions;
representing an opposite set of behaviors as an opposite graph identified as malicious if the full graph and subgraph are identified as clean, and identified as clean if the full graph and subgraph are identified as malicious; the opposite graph selected from a training set of graphs to be similar in behavior to full graph and first subgraph; and
training a graph neural network with the full graph, the first subgraph, and the opposite graph to distinguish between graphs having likely malicious and clean behavior.

17. The method of training a graph neural network to identify malicious activity in a sequence of computer instructions of claim 16, wherein the first subgraph comprises nodes and edges of the full graph determined to be most relevant to determining whether the full graph represents a malicious or clean sequence of computer instructions.

18. The method of training a graph neural network to identify malicious activity in a sequence of computer instructions of claim 16, wherein training the graph neural network comprises using a triplet loss function.

19. The method of training a graph neural network to identify malicious activity in a sequence of computer instructions of claim 16, wherein training the graph neural network is performed on a computerized system.

20. A method of training a graph neural network to identify malicious activity in a sequence of computer instructions, comprising:
identifying a plurality of behaviors of the sequence of computer instructions, the sequence of computer instructions known to be either malicious or clean;
representing the plurality of identified behaviors as a triplet of a full graph, a subgraph, and an opposite graph;
training a graph neural network with the full graph, the subgraph, and the opposite graph to distinguish between graphs having likely malicious and clean behavior.

21. The method of training a graph neural network to identify malicious activity in a sequence of computer instructions of claim 20, wherein the full graph is a full graph representing an observed behavioral snapshot, the subgraph is a subgraph induced from the full graph, and the opposite graph is generated from the subgraph.

22. The method of training a graph neural network to identify malicious activity in a sequence of computer instructions of claim 21, wherein training the subgraph is induced from the full graph by randomly pruning nodes of the full graph.

23. The method of training a graph neural network to identify malicious activity in a sequence of computer instructions of claim 21, wherein the opposite graph is generated from the subgraph by randomly replacing edges of the subgraph and by randomly permuting features of nodes of the subgraph.
